(19) United States
(12) Patent Application Publication
(10) Pub. No.: US 2021/0246976 A1
(43) Pub. Date: Aug. 12, 2021

(54) Belt Pulley Decoupler having a Belt Track, Sliding Bearing and Axial Friction Ring Injection-Molded thereon

(71) Applicant: Schaeffler Technologies AG & Co. KG, Herzogenaurach (DE)

(72) Inventors: Joseph Gissler, Friesenheim (DE); Jean Sieffert, Lingolsheim (FR); Philipp Rasch, Forst (DE)

(73) Assignee: Schaeffler Technologies AG & Co. KG, Herzogenaurach (DE)

(21) Appl. No.: 17/054,543

(22) PCT Filed: May 15, 2019
(86) PCT No.: PCT/DE2019/100441

§ 371 Date: Nov. 11, 2020

(30) Foreign Application Priority Data
May 22, 2018 (DE) 10 2018 112 162.8

(51) Int. Cl. F16H 55/48; F16D 7/02; B29C 45/14; B29C 45/16

(52) U.S. Cl. CPC F16H 55/48; F16D 7/021; B29C 45/1459; F16H 2055/366; B29C 45/1671; B29C 45/164; B29C 45/14754

(57) ABSTRACT

The present disclosure relates to a method for producing a belt pulley having a belt track, a sliding bearing injection-molded thereon, and an axial friction ring injection-molded thereon. The disclosure also relates to said belt pulley and to a belt pulley decoupler comprising said belt pulley.

### CROSS-REFERENCE TO RELATED APPLICATIONS

This application is the U.S. National Phase of PCT Appln. No. PCT/DE2019/100441 filed May 15, 2019, which claims priority to DE 10 2018 112 162.8 filed May 22, 2018, the entire disclosures of which are incorporated by reference herein.

### TECHNICAL FIELD

The present disclosure relates to a method for producing a belt pulley having a belt track, a sliding bearing injection-molded thereon, and an axial friction ring injection-molded thereon. The disclosure also relates to said belt pulley and to a belt pulley decoupler comprising said belt pulley.

### BACKGROUND

Belt pulley decouplers are used in motor vehicles with internal combustion engines or electric motors. Internal combustion engines in particular are designed in such a way that they minimize fuel consumption and CO₂ emissions. For this purpose, the engine speed and the number of cylinders of the internal combustion engine are reduced and start-stop systems are used which switch off the internal combustion engine when the vehicle is at a standstill and restart the engine when the vehicle is started again. Said measures to reduce fuel consumption and CO₂ emissions put strain on the internal combustion engine, since these also lead to increased oscillations and greater stress on the components. However, to utilize the full engine power and ensure the longevity of the components, and to provide a quiet vehicle interior free of noise and vibrations for vehicle occupants, the oscillations of the engine must be damped. A belt pulley decoupler is used for this. The belt pulley decoupler is arranged in an auxiliary drive unit of the internal combustion engine and mounted directly on the crankshaft. The belt pulley decoupler prevents oscillations or vibrations of the engine from being transmitted to other units or components. The belt pulley decoupler is essentially made up of two masses. The two masses are connected to each other via a spring-damper system. The masses are essentially two concentric components, wherein the outer mass is referred to as a belt pulley. A belt of the auxiliary drive unit is on the belt pulley. To be able to ensure a transfer of torque between the belt pulley decoupler and the belt that is as slip-free as possible, the belt pulley comprises a belt track that provides sufficient friction between the belt pulley and the belt to transfer the torque applied to the belt pulley decoupler. The belt pulley further comprises a sliding bearing to allow sliding between the belt pulley and the more inner of the two substantially concentric masses. In addition, the belt pulley has an axial friction ring.

The belt pulley or belt track is manufactured from steel, in particular soft steel suitable for cold forming, such as deep-drawing steel DD12/DD13, in a complex and costly roller-burnishing process. The sliding bearing consists of composite material and is pressed into the belt pulley or a cover of the belt pulley decoupler. The axial friction ring is made of plastic and is mounted on the belt pulley.

### SUMMARY

The object of the present disclosure is therefore to simplify the manufacture of the belt pulley and reduce the manufacturing costs thereof.

This object is achieved by the method and the belt pulley and the belt pulley decoupler according to the claims and described below.

According to a first aspect of the present disclosure, a method for manufacturing a belt pulley comprises at least one of the following non-sequential steps:

a) Injection molding of a belt track onto a base body of the belt pulley.
b) Injection molding of a sliding bearing on the base body.
c) Injection molding of an axial friction ring onto the base body.

According to a second aspect of the present disclosure, a belt pulley for a belt pulley decoupler comprises at least one belt track that is injection-molded onto a base body of the belt pulley or a sliding bearing that is injection-molded onto the base body or an axial friction ring that is injection-molded onto the base body.

According to a third aspect of the present disclosure, a belt pulley decoupler comprises a belt pulley. The belt pulley comprises at least one belt track that is injection-molded onto a base body of the belt pulley or a sliding bearing that is injection-molded onto the base body or an axial friction ring that is injection-molded onto the base body.

The base body of the belt pulley has a track surface. The track surface is an essentially radially outwardly facing circumferential surface of a cylinder on an outer circumference of the base body. The belt track is injection-molded onto the track surface of the base body in step a). The injection-molded belt track has a surface structure that provides friction between the belt track and a belt of an auxiliary drive unit. The friction is sufficient to transfer a torque applied to the belt pulley decoupler between the belt pulley and the belt. The base body also has a bearing surface. The bearing surface is an essentially radially inwardly facing circumferential surface of a cylinder on an inner recess of the base body. The sliding bearing is injection-molded onto the bearing surface of the base body in step b). The sliding bearing injection-molded thereon enables sliding between the belt pulley and a second mass of the belt pulley decoupler. The base body also has an annular surface. The annular surface is an annular disk surface essentially pointing in the axial direction around the inner recess. The axial friction ring is injection-molded onto the annular surface of the base body in step c).

Only the belt track or only the sliding bearing or only the axial friction ring can be injection-molded thereon. The belt track and/or the sliding bearing and/or the axial friction ring can also be injection-molded thereon.

By injection-molding the belt track and/or the sliding bearing and/or the axial friction ring, the complex manufacturing steps of rolling the belt pulley and/or pressing in the sliding bearing and/or installing the axial friction ring are avoided. This leads to a reduction in the manufacturing costs and manufacturing time for belt pulleys.

According to a further aspect of the present disclosure, at least two of steps a) to c) are performed simultaneously.

The belt track and/or the sliding bearing and/or the axial friction ring can be injection-molded simultaneously. This corresponds to injection-molding on of the belt track and/or of the sliding bearing and/or of the axial friction ring in a single step of the method.

The simultaneous injection-molding of several elements, namely the belt track and/or the sliding bearing and/or the axial friction ring, further reduces the manufacturing time and thus also the manufacturing costs for belt pulleys.

According to a further aspect of the present disclosure, a material comprising at least one plastic is used for the belt track in step a) or the sliding bearing in step b) or the axial friction ring in step c).

Various plastics can also be used as the material or as a component of the material for the belt track, the sliding bearing and the axial friction ring. Different materials, i.e., materials comprising in each case one or more different plastics, can also be used for the belt track and/or the sliding bearing and/or the axial friction ring. The belt track and/or the sliding bearing and/or the axial friction ring can thus consist of the same material comprising at least one plastic or of different materials each comprising at least one plastic.

The use of a material comprising plastic for the belt track and/or the sliding bearing and/or the axial friction ring as a cost-effective alternative to steel or composite material further reduces the manufacturing costs.

According to a further aspect, the base body is made of steel.

The base body of the belt pulley is manufactured by cold forming, in particular by deep drawing. The material for the base body is therefore steel, preferably softer steel suitable for cold forming, more preferably deep-drawing steel and particularly preferably DD12 steel or DD13 deep-drawing steel.

### BRIEF DESCRIPTION OF THE DRAWINGS

The present disclosure is explained in more detail below by means of exemplary embodiments illustrated in the drawings. The exemplary embodiments serve only for a better understanding of the present disclosure and are in no way to be interpreted to be limiting.

FIG. 1 shows a schematic flow diagram of a method according to the disclosure.

FIG. 2 shows a sectional view of a belt pulley according to the disclosure.

FIG. 3 shows an isometric view of a belt pulley decoupler according to the disclosure.

### DETAILED DESCRIPTION

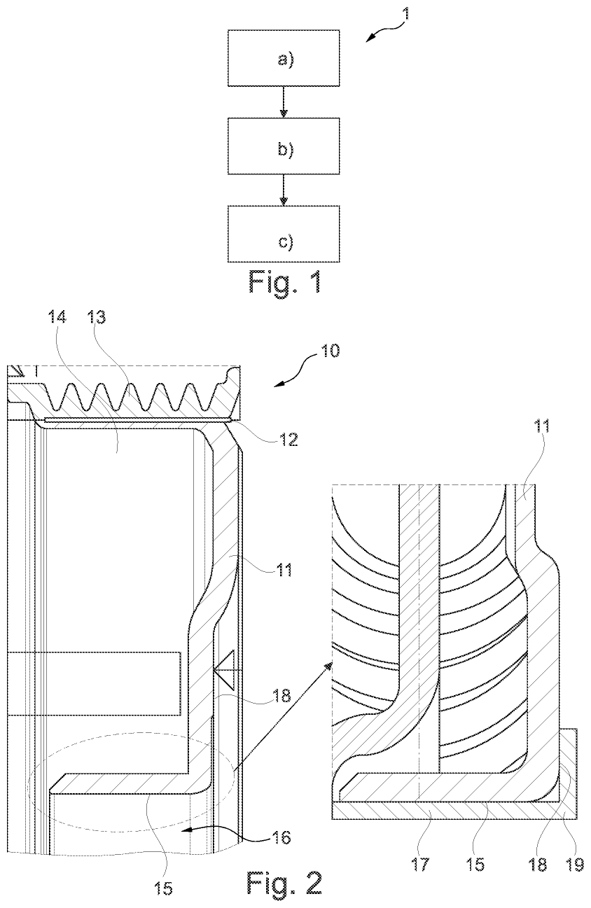

In FIG. 1 a method 1 for manufacturing a belt pulley is shown schematically. In step a) a belt track is injection-molded onto a track surface of a base body of the belt pulley. In step b) a sliding bearing is injection molded onto a bearing surface of the base body, and in step c) an axial friction ring is injection molded onto an annular surface of the base body. At least two of steps a) to c) can also be performed simultaneously. In steps a) to c) a material containing at least one plastic can be used for the belt track, the sliding bearing and/or the axial friction ring. The base body of the belt pulley can be made of steel, preferably of soft steel suitable for cold forming, more preferably of deep-drawing steel and particularly preferably of DD12 steel or DD13 steel.

In FIG. 2 a belt pulley 10 is shown in section. The belt pulley 10 comprises a base body 11 with a track surface 12, a bearing surface 15 and an annular surface 18. The track surface 12 is an essentially radially outwardly facing circumferential surface area of a cylinder on an outer circumference of the base body 11. The bearing surface 15 is an essentially radially inwardly facing circumferential surface of a cylinder on an inner recess 16 of the base body 11. The annular surface 18 is an annular disk surface essentially pointing in the axial direction around the inner recess 16.

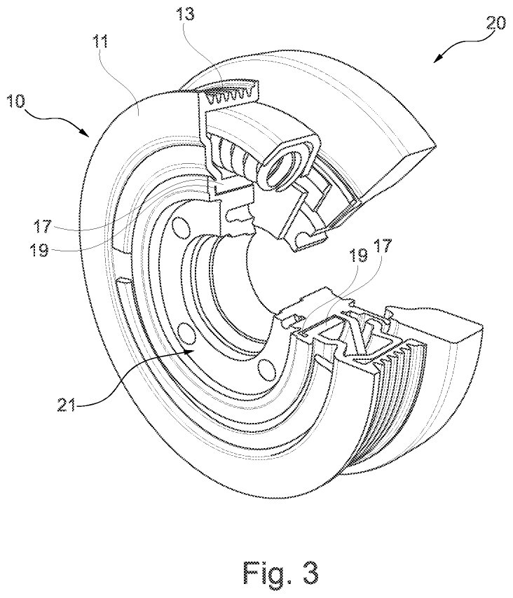

A belt track 13 is injection-molded onto the track surface 12 of the base body 11 (cf. step a) of the method according to FIG. 1). The belt track 13 can consist of a material containing at least one plastic. The injection-molded belt track 13 has a surface structure 14 that provides friction between the belt track 13 and a belt of an auxiliary drive unit. The friction is sufficient to transfer a torque applied to a belt pulley decoupler (see FIG. 3) between the belt pulley 10 and the belt. A sliding bearing 17 is injection-molded onto the bearing surface 15 (cf. step b) of the method according to FIG. 1). The sliding bearing 17 injection-molded thereon enables sliding between the belt pulley 10 and a second mass (see FIG. 3) of the belt pulley decoupler. An axial friction ring 19 is injection-molded onto the annular surface 18 (cf. step c) of the method according to FIG. 1).

In FIG. 3, a belt pulley decoupler 20 is shown isometrically. The belt pulley decoupler comprises a belt pulley 10 according to FIG. 2 and a second mass 21. The second mass 21 and the belt pulley 10 can slide against each other due to the sliding bearing 17 and the axial friction ring 19.

### LIST OF REFERENCE NUMBERS

1 Method of manufacturing a belt pulley

10 Belt pulley

11 Base body

12 Track surface

13 Belt track

14 Surface structure

15 Bearing surface

16 Inner recess

17 Sliding bearing

18 Annular surface

19 Axial friction ring

20 Belt pulley decoupler

21 Second mass

1. A method of manufacturing a belt pulley, the method comprising at least one of the following non-sequential steps:
a) injection molding of a belt track onto a base body of the belt pulley;
b) injection molding of a sliding bearing onto the base body;
c) injection molding of an axial friction ring onto the base body.

2. The method according to claim 1, wherein at least two of steps a) to c) are performed simultaneously.

3. The method according to claim 2, wherein a material comprising at least one plastic is used for the belt track in step a) or the sliding bearing in step b) or the axial friction ring in step c).

4. The method according to claim 3 wherein the base body is made of steel.

5. A belt pulley for a belt pulley decoupler, belt pulley comprising:
a belt track which is injection-molded onto a base body of the belt pulley or
a sliding bearing which is injection-molded onto the base body or
an axial friction ring which is injection-molded onto the base body.

6. The belt pulley according to claim 5, wherein the belt track or the sliding bearing or the axial friction ring comprises a material containing at least one plastic.

7. The belt pulley according to claim 5, wherein the base body is made of steel.

8. A belt pulley decoupler comprising a belt pulley, wherein the belt pulley comprises:
a belt track which is injection-molded onto a base body of the belt pulley;
a sliding bearing which is injection-molded onto the base body; and
an axial friction ring which is injection-molded onto the base body.

9. The belt pulley decoupler according to claim 8, wherein the belt track, the sliding bearing, and the axial friction ring comprise a material containing at least one plastic.
